(19) United States
(12) Patent Application Publication
(10) Pub. No.: US 2006/0286513 A1
(43) Pub. Date: Dec. 21, 2006

(54) Sign language educational doll

(76) Inventor: Sandra McLellan, Burnaby (CA)

Correspondence Address: SHLESINGER, ARKWRIGHT & GARVEY LLP;Suite 600, 1420 King Street, Alexandria, VA, 22314, US

(21) Appl. No.: 11/416,456

(22) Filed: May 3, 2006

Related U.S. Application Data
(63) Continuation of application No. PCT/CA04/01907, filed on Nov. 2, 2004.

(30) Foreign Application Priority Data
Nov. 3, 2003 (CA) 2,448,334

(51) Int. Cl. G09B 21/00

(52) U.S. Cl. 434/112

(57) ABSTRACT

An apparatus and method are disclosed for a doll for demonstrating sign language elements, particularly the American Manual Alphabet (“AMA”). The doll comprises an electromechanical arm and hand controllable to demonstrate sign language. The doll also comprises an audio means for vocalizing the verbal equivalent of the AMA sign, and a display means for displaying the Latin alphabet equivalent of the sign language element. The doll also comprises an electronic controller including a circuit board, a processor, a memory and interface headers. The doll includes an electromechanical arm and hand with solenoid and spring driver moveable components. A method of demonstrating sign language with an electromechanical hand is also provided. The hand is controllable to demonstrate sign language either on demand or in sequence, and in combination with audio components including the alphabet song, and visual components.

### 1. TECHNICAL FIELD

The present invention relates generally to electronic devices which teach or demonstrate sign language. The present invention relates specifically to a doll that serves as a means for teaching sign language both visually and audibly.

### 2. BACKGROUND OF THE INVENTION

Technology relating to communication with sign language may be divided into three major areas: educational devices used to teach sign language; systems that provide a means for inputting data into a computer using sign language; and devices that receive input from a computer keyboard then demonstrate sign language using some form of hand.

Educational Devices

U.S. Pat. No. 4,378,215 (“215”) to Sparks discloses an educational apparatus for teaching the American Manual Alphabet (“AMA”) to individuals, especially to the blind and/or deaf. The apparatus consists of a plurality of three-dimensional moulded figures of the human hand mounted on a base and each formed in a respective letter of the AMA. A disadvantage of the '215 apparatus is that the apparatus can only demonstrate the final hand positions of the AMA letters and not the required interim movements. A further disadvantage is that the '215 apparatus is limited to visual demonstration of the AMA. Finally, the apparatus is not engaging for children and therefore has limited educational potential.

U.S. Pat. No. 4,799,889 to Yockey discloses a stuffed bear for teaching sign language to deaf children. The stuffed bear utilizes a pair of hollow tubular arms through which the arms of a teacher pass, so that the hands project beyond the front edge surface of each arm. The complete articulation of the arm may be achieved to allow for the signs of sign language to be performed. This doll requires a skilled operator in AMA to manipulate the doll and provide educational value.

U.S. Pat. No. 4,878,843 to Kuch discloses a process and an apparatus for a system of animation and a system of teaching finger spelling. The Kuch patent is limited to providing visual images of hands which demonstrate finger positions and does not provide a physical hand that can be looked at and touched and so is uninteresting to children.

Systems for Inputting Data and Translating Sign Language

U.K. Pat. No. 2,302,583 (“583”) to Klein et al. discloses gloves and a hand tapper for communicating with deaf-blind people. The '583 patent teaches that words can be entered into a computer character by character using sign language read via a pair of gloves having electrodes disposed on their surfaces worn by the operator. Circuitry is used to uniquely identify the hand sign being made, and a hand tapper reads out the signs for a deaf-blind individual.

U.S. Pat. No. 5,047,952 to Kramer et al. discloses a communication system for deaf, deaf-blind, or non-vocal individuals using an instrumented glove for obtaining electrical signals indicative of a hand configuration of the individual. These electrical signals are processed and applied to a computer which subsequently outputs to a second individual. The output means depends upon the visual, vocal and hearing capabilities of the individuals but could comprise a voice synthesizer, LCD monitor, or Braille display.

U.S. patent application No. US 2002/0152077 A1 to Patterson discloses a method and apparatus for translation of hand positions into symbols. The invention comprises a glove for detecting the configuration of an individual's hand and an output device that produces either a visual or audio output corresponding to the hand position.

The above data input systems are limited to taking sign language as input; they do not demonstrate or teach how to perform the finger movements of sign language.

Devices Which Receive Input From a Keyboard

U.S. Pat. No. 4,074,444 (“444”) to Laenger, Sr. et al. discloses a method and apparatus for communicating with deaf-blind individuals. The apparatus comprises a keyboard controlled electromechanical arm. The electromechanical arm is programmed to form the letters of the standard one-hand manual alphabet through the use of an electronic buffer between the electric typewriter and the electromechanical arm. Deaf and/or deaf-blind individuals feel or observe the configuration of the electromechanical arm and are able to identify the letters being typed on the keyboard.

The '444 patent discloses an electromechanical arm that is mounted on a controlling means. Such a design is not suitable or convenient for a doll. Further, the hand in the '444 patent consists of cable-pulled fingers, which is impractical in a doll. The disclosure that the electromechanical arm can not effectively demonstrate the more complicated hand movements required for letters such as J or Z. Finally, the controlling means requires input from the typewriter means, and it cannot operate autonomously.

The manual alphabet can be found in Riekehof, The Joy of signing, Gospel Publishing House, 1445 Boonville Ave., Springfield, Mo., p.15 (ISBN-0-88243-518-3).

Devices that communicate and teach sign language are not unique. There is, however, a need for a teaching apparatus which provides a physical hand and additional educational aids to teach people sign language in a fun and pedagogically sound manner.

### 3. SUMMARY OF THE INVENTION

An apparatus for a sign language element demonstrating doll comprising an electromechanical arm and hand positionally adjustable in a manner operative to demonstrate sign language elements is provided. Advantageously, the doll may further include an audio system for vocalizing the verbal equivalent of the sign language elements and a display system for displaying the Latin alphabet equivalent of the sign language elements. The audio and visual systems may comprise a speaker and a display screen which simultaneously broadcast and display the equivalent of the sign language elements which are being demonstrated by the doll.

Preferably the sign language elements are the American Manual Alphabet (“AMA”) signs corresponding to the characters of the Latin alphabet. The electromechanical hand displays the AMA signs in sequence, while simultaneously broadcasting the equivalent name of the sign in a spoken language and displaying the Latin alphabet equivalent of the sign on the display screen. The sign language element may be a sign representing a single letter of an alphabet, a word or a phrase.

Further, the doll for demonstrating sign language may comprise an electromechanical arm attached to a right shoulder having a forearm segment, a hand segment and finger segments, an electronic controller including circuit board, a processor, a memory and interface headers, an electronic display, an audio means, an electronic display screen, an audio output and a power supply.

Further advantageously, a hand of the doll is comprised of a plurality of joints, springs and solenoids such that when the solenoids are activated, the finger segments are flexed about the corresponding joint, and when the solenoids are deactivated, the springs return the finger segments to a neutral extended position. The doll may also comprise a wrist joint and an elbow joint including multi-position solenoids, operable in at least three positions.

The electronic display may be an alphanumeric light emitting diode display, and the audio means may be a piezo-electric speaker. The processor may be a microcontroller, and the power supply may be a 6 volt rechargeable battery.

Advantageously the electromechanical hand may have a hand segment and finger segments for demonstrating sign language comprised of: four independently controllable fingers with at least one joint each and moveably attached to the hand segment by one joint; an independently controllable thumb with at least one joint and moveably attached to the hand segment by one joint; and a controller having a processor and a memory and being attached to the hand. The hand may additionally comprise an electromechanical arm having a forearm segment, the hand being moveably attached at a distal end of the forearm segment, such that the forearm segment is moveable to demonstrate sign language.

Advantageously, the electronic display may be an alphanumeric light emitting diode or a backlit liquid crystal display attached to the electromechanical arm. The audio output may be a piezo-electric speaker. The memory may be an interchangeable memory card.

The doll may include at least one spring and at least one electric solenoid disposed at each joint wherein when the solenoids are activated, the segments are flexed and wherein when the solenoids are deactivated, the springs extend the segments to a neutral anatomical position.

A method of sequentially demonstrating the hand and finger positions of the American Manual Alphabet using an electromechanical arm while concurrently displaying the letter being signed on a digital display and concurrently providing an audial representation of the letter being signed through an audio device is also disclosed. The method includes the steps of: turning a switch on the doll to an on position; controlling an electromechanical arm, hand, and fingers to form a physical representation of a sign language component and simultaneously controlling an audio output device to emit a sound corresponding to the sign language component; and simultaneously controlling a display device to show the Latin character corresponding to the sign language component.

A method of demonstrating sign language with a doll having an electronic control device, an audio output device, a visual display device and a plurality of joints manipulatable by a flexional device comprising the steps of: controlling the manipulatable joints in at least one finger, and an elbow and wrist of the doll to form a sign language; and simultaneously emitting the sound corresponding to the sign from the audio output device; and simultaneously displaying the Latin letter equivalent of the sign on the visual display device is disclosed.

Advantageously, the flexional devices are electrical solenoids, which may be controlled to flex the fingers, hand and wrist to form the sign character by deactivating the solenoids then returning the fingers, hand and wrist to a neutral position by means of at least one spring under tension.

### 4. BRIEF DESCRIPTION OF THE DRAWINGS

The apparatus and method of the present invention will now be described with reference to the accompanying drawing figures, in which:

FIG. 1 is a front view of the doll according to the invention.

FIG. 2 is a rear view of the doll with the cavity in the open position, according to the invention.

FIG. 3 is a detailed top view of the electromechanical arm according to the invention.

FIG. 4 is a detailed top view of the plunger assembly according to the invention.

FIG. 5 is a detailed top view of the electromechanical hand according to the invention.

FIG. 6 is a detailed bottom view of the electromechanical hand according to the invention.

FIG. 7 is a diagramatic view of the controller board according to the invention.

FIG. 8 is a diagramatic view of a variation of the control section according to the invention.

FIG. 9 is a diagramatic view of a variation of the control section according to the invention.

### 5. DETAILED DESCRIPTION OF THE PREFERRED EMBODIMENT

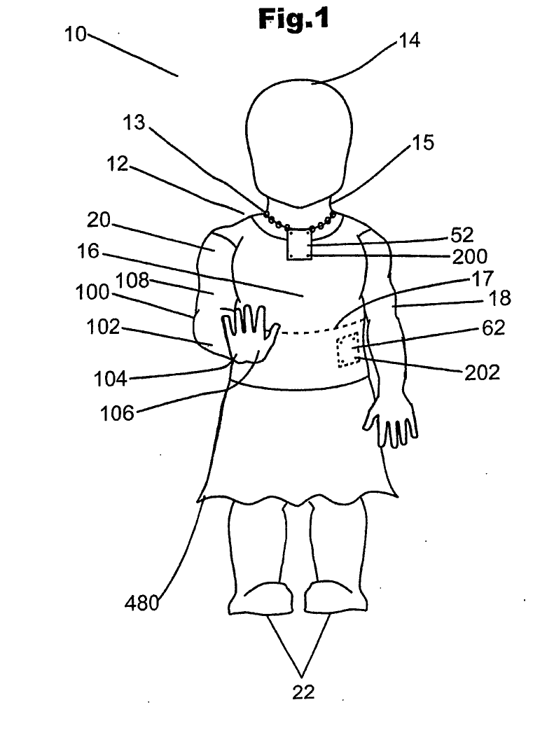

FIG. 1 is a front view of a doll 10 which is a fun and educational learning tool for children. The doll 10 is an accessible educational tool from which all individuals, regardless of physical limitations, can learn. Blind individuals can learn sign language by feeling the hand and listening to the audible accompaniment. Deaf individuals can learn by observing the hand position and the corresponding letter being displayed on the electronic display. Individuals without physical limitations will benefit from three concurrent learning aids.

The preferred embodiment of the invention is a toy-like doll 10 that demonstrates the finger and hand movements of the American Manual Alphabet (“AMA”). The preferred embodiment of the invention teaches the AMA, and variations of the present invention teach other forms of sign language.

An advantage of the doll 10 is its form. An isolated hand is not as conducive to learning for children as the doll 10. The doll 10 presents the opportunity for a child to form a bond with the doll 10, which has a far-reaching value for educating children.

The doll 10 is comprised of a body 12 with a head 14, torso 16, left arm 18, hollow right upper arm 20 and legs 22. In the preferred embodiment the body 12 is modelled on a human child and the height of the body 12, including the head 14, torso 16 and legs 22, is between 68 cm (28″) and 90 cm (36″). Optimally, the doll 10 is approximately 73 and (30″) in length. The body 12 is made of a human skin coloured toy-grade plastic such as polyurethane. Any other material that has equivalent strength and durability may be substituted.

The doll 10 is covered by clothing such as a dress 480 which serves to make the doll 10 more lifelike. The clothing 480 may be removed so that a child may dress and undress the doll 10. A variety of clothing 480 styles and types may be used to dress the doll 10.

An electronic letter display 52 is recessed in the upper left front chest area of the torso 16 by fasteners 200 which are preferably commercially available nuts and bolts. Any other fastening means such as screws may be used. In the preferred embodiment, the electronic letter display 52 is an alphanumeric such as Fairchild™ Semiconductor part number MSA5460C. Any suitable electronic letter display technology can be used, such as alphanumeric LED (light emitting diode) displays and LCD's (liquid crystal displays).

An audio output device 62 is recessed in the lower left front chest area of the torso 16 by fasteners 202 which are preferably commercially available nuts and bolts. Any other fastening means such as screws may be used. The audio output device 62 is preferably a piezoelectric-type speaker. Any such audio device, with sufficient dynamic range to reproduce clearly the human voice, specifically a frequency range of approximately 30 Hz to 14 kHz, can be used. This includes, for instance, a cone speaker.

An electromechanical arm subsystem 100, comprising a forearm 102, a hand 104, and a skin covering 108, is attached to the hollow right upper arm 20. The proximal end of forearm 102 is attached (the details of the attachment provided below) to the distal end of the upper arm 20 and fixed at an approximately 45 degree angle. The hand 104 is attached to the forearm 102 (details of attachment provided below). The arm subsystem 100 is positioned so that the hand 104 is generally above the waistline 17 of the doll 10 with the palm 106 facing generally forward and in front of the torso 16. This position is the most common signing position. The arm subsystem 100 is covered by a skin covering 108 which serves to protect the components of the arm, described below, and make the doll 10 look more lifelike. The skin 108 must be flexible enough to allow the fingers and wrist of the hand 104 to move and bend. The skin 108 is preferably a human skin coloured polyurethane rubber. Other materials may be used such as silicon rubber; fur may be used to make the doll look like a teddy bear.

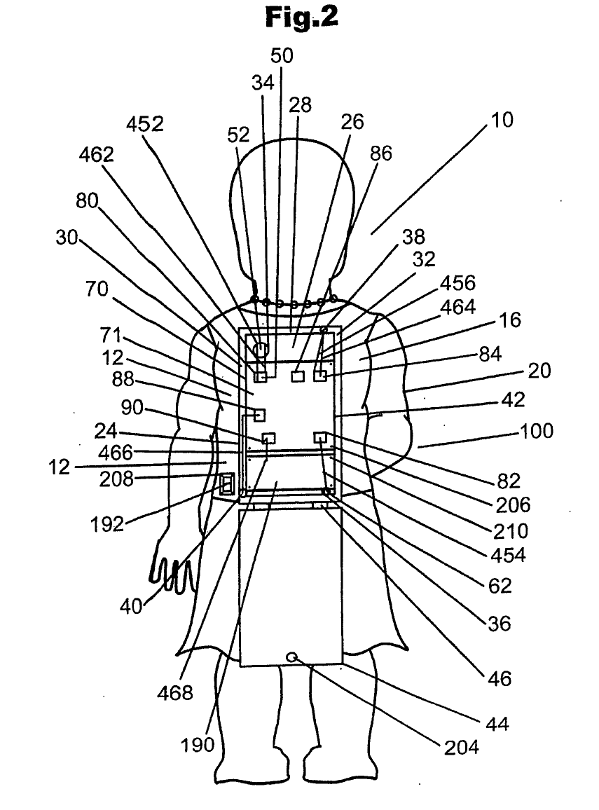

Referring now to FIG. 2, a diagrammatic rear view of the doll 10 according to the invention, the torso 16 includes a cavity 24 that is disposed in the back area of the torso 16. The cavity 24 is generally shaped like an open cube or box. In the preferred embodiment, the cavity 24 is approximately 51 mm (2″) in depth, 102 mm (4″) in width and 102 mm (4″) in height. The cavity 24 is comprised of a back wall 26, a top wall 28, a left wall 30 and a right wall 32. A display opening 34 is disposed in the upper area of the back wall 26 and provides access to the backside of the display 52. An audio opening 36 is disposed in the lower area of the back wall 26 and provides access to the backside of the audio device 62. An arm opening 38 is disposed in the top wall 28 and provides access to the arm subsystem 100. A power switch opening 40 is disposed in the lower area of the left wall 30 and provides access to the backside of the power switch 192. The display opening 34, audio opening 36, arm opening 38 and power switch opening 40 are generally circular and approximately 13 mm (½″) in diameter.

Access to the components contained in the cavity 24, for servicing and maintenance, is provided by a generally rectangular opening 42 disposed in the back area of the torso 16. The opening 42 is covered with a generally rectangular cover 44 shown here in the open position. When the cover 44 is closed, the opening 42 is completely covered by the cover 44 and damage to the components contained in the cavity 24 is thereby prevented. The proximal edge of the cover 44 is attached to the body 12 by at least two hinges 46 and the distal edge of the cover 44 is secured by a cover fastener 204. The cover fastener 204 is preferably a commercially available nut and bolt or screw.

A controller 70 is attached to the upper portion of the back wall 26 by fasteners 206 which are preferably commercially available nuts and bolts. Any other fastening means such as screws may be used. The controller 70 is comprised of a circuit board 71, display header 80, audio header 82, arm power header 84, arm control header 86, power switch header 88, and power supply header 90.

The backside of the display 52 is connected by a plurality of display power wires 462 and display control wires 452 to the display header 80 through the display opening 34. The backside of the audio output 62 is connected by a plurality of audio output wires 454 to the audio header 82 through audio opening 36. A plurality of arm control wires 456 are connected between arm subsystem 100 and the arm control header 86 through arm opening 38. A plurality of arm power wires 464 are also connected between arm subsystem 100 and the arm power header 84 through arm opening 38.

A power switch 192 is recessed in the lower left rear area of the torso 16 by switch fasteners 208 which are preferably commercially available nuts and bolts. Any other fastening means such as screws may be used. In the preferred embodiment the switch 192 is a commercially available toggle switch. Other switch types such as pushbutton switches may be used. The switch 192 is connected to the power switch header 88 by a plurality of switch power wires 466.

A power supply 190 is attached to the lower portion of back wall 30 by fasteners 210 which are preferably commercially available nuts and bolts. Any other fastening means such as screws may be used. A plurality of controller power wires 468 are connected at one end to the power supply 190 and at the other end to the power supply header 90. The power supply 190 preferably comprises a rechargeable 6 volt battery. Other battery types may be used, such as standard C cell or D cell batteries. Alternatively, an AC-DC power supply may be used. In the preferred embodiment 6 volts direct current is used, but the voltage may increase or decrease for variations of the doll 10.

All electric control wires 452 and 456 and electrical power wires 462, 464, 466 and 468 are preferably tie-wrapped and attached to torso 16 at a multiplicity of plastic clips moulded within torso 16 in a method common to the art.

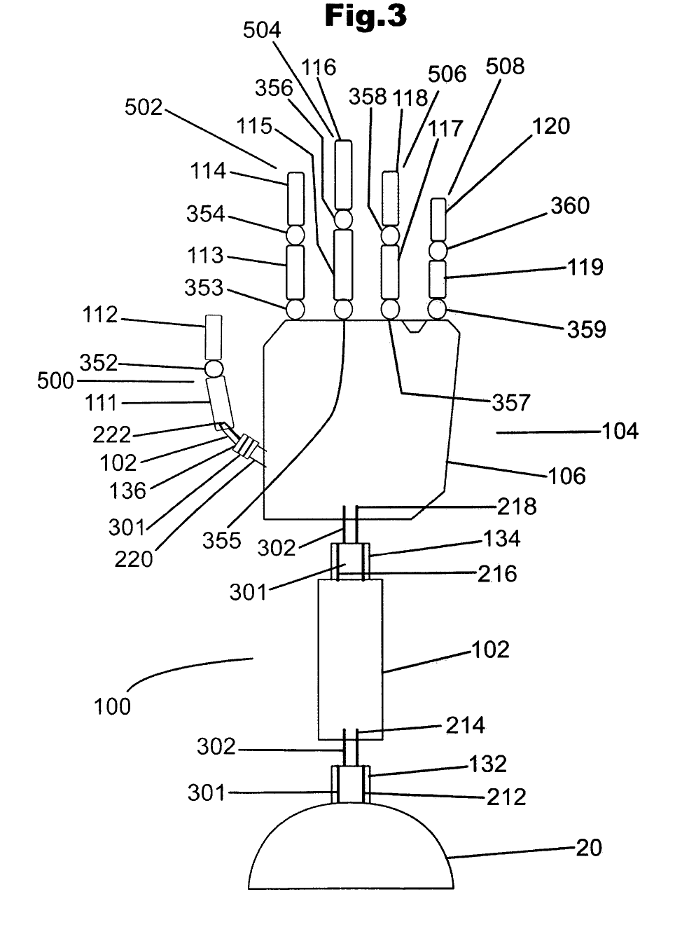

Referring now to FIG. 3, a detail, top view of the electromechanical arm, generally referred to by 100, is shown. The electromechanical arm 100 is a human-like arm that is capable of reproducing the finger and hand movements of the American Manual Alphabet. The AMA is inherently tolerant to inaccuracies in finger and hand position. Meaning is not lost as long as fingers are held in an approximate position representative of the correct AMA hand position. Although the arm subsystem 100 has been designed to accurately form the AMA hand positions, some flexibility in accuracy is permissible due to the typical and allowable variation of hand position for the AMA.

The arm subsystem 100 is composed of a plurality of cylindrical segments. The segments are preferably constructed from polyethylene plastic, but may be constructed from any other commercially available light weight, rigid material such as aluminium metal. Each segment is connected by a joint which is preferably a ball and socket joint. In the preferred embodiment the arm subsystem 100 is preferably between approximately 18 cm (7″) and 22 cm (9″) in length.

The arm subsystem 100 is comprised of a forearm segment 102, a hand 104, and solenoids 132 and 134. The solenoids 132 and 134 are comprised of a housing 301 and a plunger 302. The housing 301 of the elbow solenoid 132 is attached to the left side of the distal end of the hollow right upper arm 20 by elbow solenoid fasteners 212 which are preferably commercially available nuts and bolts. The left side of the proximal end of the forearm segment 102 is connected to the plunger 302 of the solenoid 132 by forearm fasteners 214. The forearm 102 is preferably between approximately 10 cm (4″) and 13 cm (5″) in length. The housing 301 of the wrist solenoid 134 is attached to the underside of the distal end of the forearm 102 by wrist solenoid fasteners 216 which are preferably commercially available nuts and bolts. The proximal end of the hand 104 is attached to the plunger 302 of the solenoid 134 by wrist fasteners 218. Both the solenoid 132 and 134 are preferably multi-position solenoids and comprise a proximal end, and a distal end. The proximal and distal ends correspond to the proximal and distal end ends of the forearm segment 102.

The hand 104 is comprised of a plurality of cylindrical segments. The segments are preferably constructed from polyethylene plastic, but may be constructed from any other commercially available light weight, rigid material such as aluminium metal. Each segment is connected by a joint which is preferably a ball and socket joint, but may also be connected using tongue/groove/pin connections. In the preferred embodiment the hand 104 is preferably between approximately 8 cm (3″) and 10 cm (4″) in length.

The interconnection of the cylindrical segments will now be described. The hand 104 is comprised of a palm 106, a thumb, a first finger, a second finger, a third finger and a fourth finger. The palm 106 is generally quadrilateral in shape and is preferably constructed from polyethylene plastic, but may be constructed from any other commercially available lightweight, rigid material such as aluminium metal.

The thumb 500 is comprised of a lower thumb segment 111 and an upper thumb segment 112. The housing 301 of a first thumb solenoid 136 is attached to the left side of the palm 106 by thumb solenoid fasteners 220. The plunger 302 of solenoid 136 is connected to the proximal end of a lower thumb segment 111 by a thumb segment fastener 222. The distal end of the lower thumb segment 111 is connected to the proximal end of an upper thumb segment 112 by a joint 352. The first thumb solenoid 136 is preferably a commercially available multi-position solenoid.

The first finger is comprised of a first finger lower segment 113 and a first finger upper segment 114. The proximal end of a first finger lower segment 113 is connected to the distal end of the palm 106 by a joint 353. The distal end of first finger lower segment 113 is connected to the proximal end of a first finger upper segment 114 by a joint 354.

The second finger is comprised of a second finger lower segment 115 and a second finger upper segment 116. The proximal end of a second finger lower segment 115 is connected to the distal end of the palm 106 by a joint 355. The distal end of second finger lower segment 115 is connected to the proximal end of a second finger upper segment 116 by a joint 356.

The third finger is comprised of a third finger lower segment 117 and a third finger upper segment 118. The proximal end of a third finger lower segment 117 is connected to the distal end of the palm 106 by a joint 357. The distal end of third finger lower segment 117 is connected to the proximal end of a third finger upper segment 118 by a joint 358.

The fourth finger is comprised of a fourth finger lower segment 119 and a fourth finger upper segment 120. The proximal end of a fourth finger lower segment 119 is connected to the distal end of the palm 106 by a joint 359. The distal end of the fourth finger lower segment 119 is connected to the proximal end of a fourth finger upper segment 120 by a joint 360.

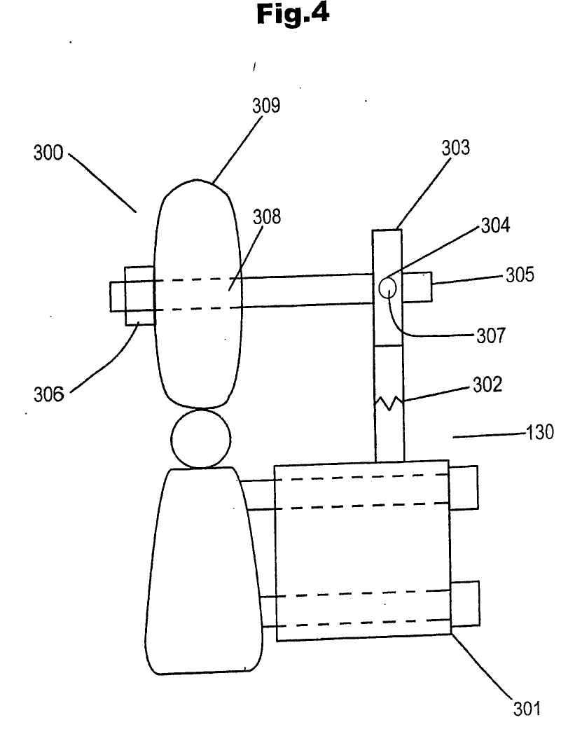

Referring now to FIG. 4, a top view of the preferred embodiment of the solenoid plunger fastening means 300 is shown. Note that the components are not shown to scale, as indicated by the break line in plunger 302. A solenoid 130 is comprised of a housing 301 and a plunger 302. The plunger 302 is connected internally within the housing 301. The distal end of the plunger 302 is preferably comprised of a metal fork 303 with a hole 304 there through. A rod 305 is inserted transversely between the times of the fork 303 and a pin 307 is inserted through both the times and the rod 305. The rod 305 is inserted through a hole 308 in the finger segment 309 and a nut 306 is attached to the opposite end of the rod 305 thereby retaining it to the finger segment 309. The pin 307 is preferably a commercially available cotter pin. The nut 306 is preferably a commercially available nut. The rod 304 is preferably a commercially available bolt, with a hole drilled through the non-threaded end. The components such as the plunger 302, rod 305 and finger segment 309 are not shown to scale. The lengths of the components must be sized to permit flexion and extension of the finger segments.

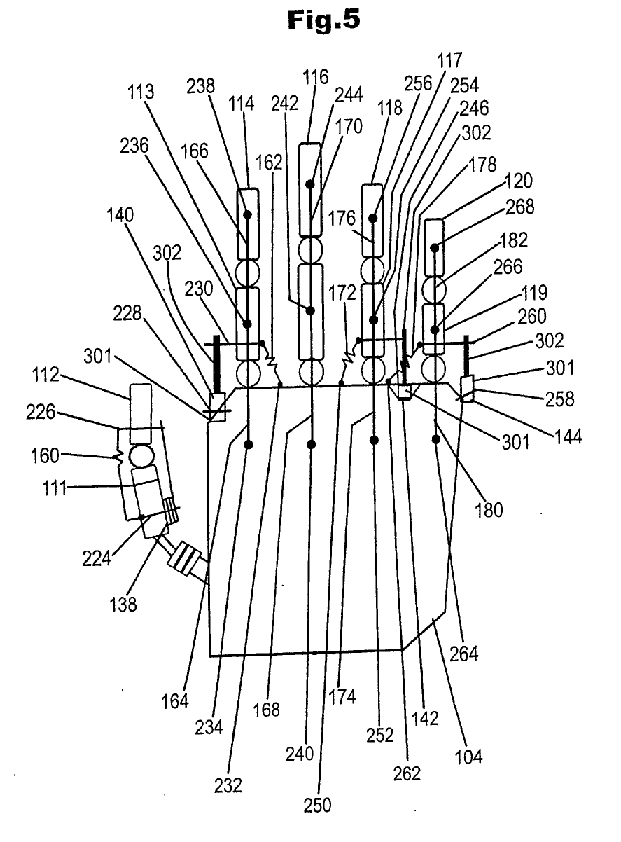

Referring now to FIG. 5, a top view of the preferred embodiment of the hand 104 is shown. A plurality of springs and solenoids 130 are attached to certain locations on the fingers and the hand 104. The solenoids 130 are comprised of a proximal end, and a distal end. The proximal and distal ends correspond to the proximal and distal end ends of the finger segments 111-120.

The housing 301 of a second thumb solenoid 138 is connected to the right side of lower thumb segment 111 by fasteners 224; the plunger 302 of solenoid 138 is connected to thumb segment 112 by a plunger assembly 300. Thumb spring 160 is connected at one end to the left side of the thumb segment 111 and at the other end to the left side of thumb segment 112 by fasteners 226.

The housing 301 of a first finger solenoid 140 is connected to the left side of the palm 106 by first finger solenoid fasteners 228. The plunger 302 of the first finger solenoid 140 is connected to the finger segment 113 by a plunger assembly 300. A first finger side spring 162 is connected at one end to the distal end of the palm 106 by a fastener 232 and at the other end to the left side of the finger segment 113 by the fastener 230. A first finger lower spring 164 is attached at one end to the top side of the palm 106 by a fastener 234 and at the other end to the top side of the finger segment 113 by a fastener 236. A first finger upper spring 166 is attached at one end to the top side of the finger segment 113 by a fastener 236 and at the other end to the top side of the finger segment 114 by a fastener 238.

A second finger lower spring 168 is attached at one end to the top side of the palm 106 by a fastener 240 and at the other end to the top side of the finger segment 115 by a fastener 242. A second finger upper spring 170 is attached at one end to the top side of the finger segment 115 by a fastener 242 and at the other end to the top side of the finger segment 116 by a fastener 244.

The housing 301 of a third finger solenoid 142 is recessed in the distal end side of the palm 106, on the right side of finger segment 117, by third finger solenoid fasteners 246. The plunger 302 of the third finger solenoid 142 is connected to the finger segment 117 by a plunger assembly 300. A third finger side spring 172 is connected at one end to the distal end of the palm 106 on the left side of finger segment 117 by a fastener 250 and at the other end to the right side of the finger segment 117 by a related fastener. A third finger lower spring 174 is attached at one end to the top side of the palm 106 by a fastener 252 and at the other end to the top side of the finger segment 117 by a fastener 254. A third finger upper spring 176 is attached at one end to the top side of the finger segment 117 by the fastener 254 and at the other end to the top side of the finger segment 118 by a fastener 256.

The housing 301 of a fourth finger solenoid 144 is connected to the right side of the palm 106 by fourth finger solenoid fasteners 258. The plunger 302 of the fourth finger solenoid 144 is connected to the finger segment 119 by a plunger assembly 300. A fourth finger side spring 178 is connected at one end to the distal end of the palm 106 by a fastener 262 and at the other end to the left side of the finger segment 119 by the fastener 260. A fourth finger lower spring 180 is attached at one end to the top side of the palm 106 by a fastener 264 and at the other end to the top side of the finger segment 119 by a fastener 266. A fourth finger upper spring 182 is attached at one end to the top side of the finger segment 119 by a fastener 266 and at the other end to the top side of the finger segment 120 by a fastener 268.

All springs 160 are under tension when the corresponding finger segments 111-120 are in the flexed position, and relaxed when the corresponding finger segments 111-120 are in the extended position.

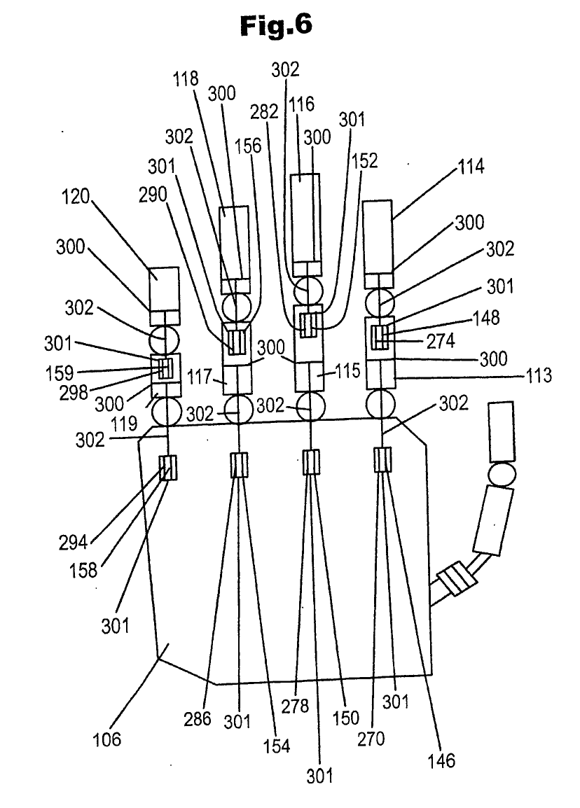

Referring now to FIG. 6, a bottom view of the preferred embodiment of the hand 104 is shown. The housing 301 of a first finger lower solenoid 146 is connected to the bottom side of the palm 106 by first finger lower solenoid fasteners 270. The plunger 302 of the first finger lower solenoid 146 is connected to the finger segment 113 by a plunger assembly 300. The housing 301 of a first finger upper solenoid 148 is connected to the bottom side of the finger segment 113 by first finger upper solenoid fasteners 274. The plunger 302 of the first finger upper solenoid 148 is connected to the finger segment 114 by a plunger assembly 300.

The housing 301 of a second finger lower solenoid 150 is connected to the bottom side of the palm 106 by second finger lower solenoid fasteners 278. The plunger 302 of the second finger lower solenoid 150 is connected to the finger segment 115 by a plunger assembly 300. The housing 301 of a second finger upper solenoid 152 is connected to the bottom side of the finger segment 115 by second finger upper solenoid fasteners 282. The plunger 301 of the second finger upper solenoid 152 is connected to the finger segment 116 by a plunger assembly 300.

The housing 301 of a third finger lower solenoid 154 is connected to the bottom side of the palm 106 by third finger lower solenoid fasteners 286. The plunger 302 of the third finger lower solenoid 154 is connected to the finger segment 117 by a plunger assembly 300. The housing 301 of a third finger upper solenoid 156 is connected to the bottom side of the finger segment 117 by third finger upper solenoid fasteners 290. The plunger 302 of the third finger upper solenoid 156 is connected to the finger segment 118 by a plunger assembly 300.

The housing 301 of a fourth finger lower solenoid 158 is connected to the bottom side of the palm 106 by fourth finger lower solenoid fasteners 294. The plunger 302 of the fourth finger lower solenoid 158 is connected to the finger segment 119 by a plunger assembly 300. The housing 301 of a fourth finger upper solenoid 159 is connected to the bottom side of the finger segment 119 by fourth finger upper solenoid fasteners 298. The plunger 302 of the fourth finger upper solenoid 159 is connected to the finger segment 120 by a plunger assembly 300.

The use of solenoids 130 and springs 160 in the preferred embodiment is not intended to limit the scope of the invention. Other technologies which provide the same functionality, such as air-piston solenoids, may be used in place of the electric solenoids.

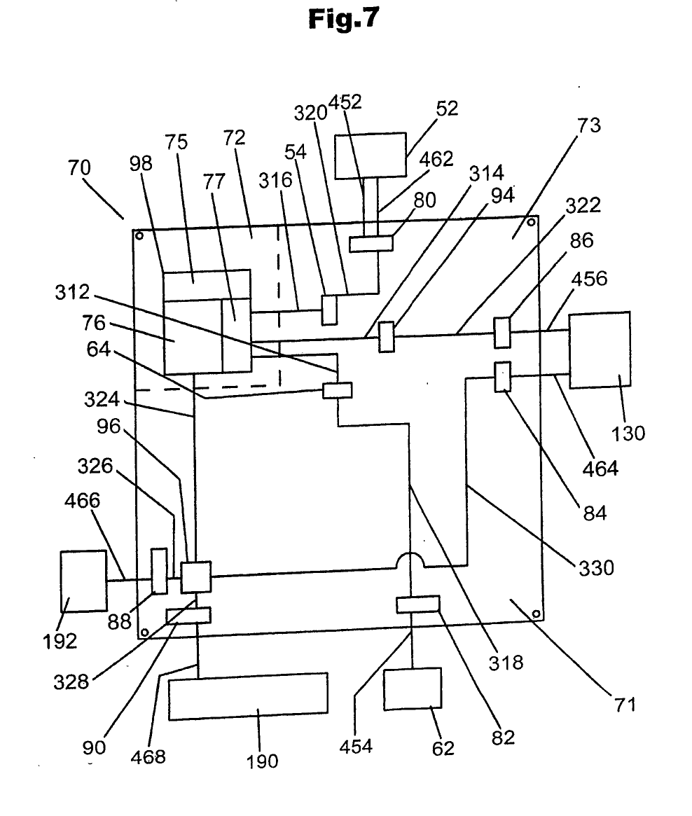

Referring now to FIG. 7, the controller 70 which is comprised of a circuit board 71 with a control section 72 and an interface section 73, is shown. The circuit board 71 is preferably a commercially available printed circuit board with etched traces.

The control section 72 is comprised of a memory 75, a processor 76, and an input/output (“I/O”) 77. In the preferred embodiment, the control section 72 is implemented using a single microcontroller 98 (otherwise known in the art as an embedded system). The memory 75, the processor 76 and the I/O 77 are contained within the microcontroller 98 which is a single hermetically sealed package. In the preferred embodiment the microcontroller 98 is implemented using a commercially available microcontroller such as the Motorola™ MC68CH11.

The interface section 73 is comprised of a display header 80, an audio header 82, an arm power header 84, an arm control header 86, a power switch header 88, a power supply header 90, a display controller 54, an audio driver 64, a solenoid driver 94, and a power regulator 96. The headers 80, 82, 84, 86, 88, and 90, audio driver 64, solenoid driver 94, display controller 54, power regulator 96 are commercially available components.

In the preferred embodiment, the microcontroller 98 is soldered to circuit board 71. The I/O section 77 of the microcontroller 98 is connected electrically via etched traces to the interface section 73. The I/O section is connected to the audio driver 64 by traces 312, to the solenoid driver 94 by traces 314 and to the display controller 54 by traces 316.

The audio driver 64 is connected by traces 318 to the audio header 82. The audio header 82 is connected to the audio output 62 by a plurality of wires 454. The display controller 54 is connected by traces 320 to the display header 80. The display header 80 is connected to the display 52 by a plurality of display power wires 462 and display control wires 452. The solenoid driver 94 is connected by traces 322 to the arm control header 86. The arm control header 86 is connected to the solenoids 130 by a plurality of arm control wires 456. The power regulator 96 is connected by traces 324 to the microcontroller 98. The power regulator 96 is also connected to the power switch header 88 by traces 326. The power switch header 88 is connected to the power switch 192 by wires 466. The power regulator 96 is also connected to the power supply header 90 by traces 328. The power supply header 90 is connected to the power supply 190 by wires 468. The power regulator 96 is also connected to the arm power header 84 by the traces 330. The arm power header 84 is connected to the solenoids 130 by arm power wires 464.

An explanation of the function and interaction of these subsystems is now provided. The electronic letter display subsystem 50, comprising a display 52 and a display controller 54, provides supplementary visual representation of the AMA letter being signed. The audio subsystem 60, comprising a speaker 62 and a speaker driver 64, provides an audible representation of the AMA letter being signed. The arm subsystem 100, comprising a plurality of solenoids 130 and springs 160, forms the hand positions for the letters of the AMA. Controller 70 controls the subsystems through control wires 450. The controller 70 also synchronizes the display output and the audio output with the movements of the arm subsystem 100. The power supply 190 supplies power to the display subsystem 50, the audio subsystem 60, the controller 70, and the arm subsystem 100 via electrical power wires 460.

The control section 72 controls the operation of these subsystems by issuing control signals to them. The control section 72 determines which control signals to issue in the processor 76. In operation, the processor 76 receives input from the memory 75, processes the input, and generates output for the subsystems via the I/O 77. In particular, the processor 76 has the function of sending control signals to the solenoid driver 94 which cause the driver 94 to output control signals to the solenoids 150 in the arm subsystem 100; sending signals to the display controller 54 so that appropriate letter is displayed; and translating the digital audio samples from the memory 75 into analog audio signals that are output to the audio driver 64. Further, the processor 76 synchronizes the various subsystems so that they operate concurrently.

Referring now to FIG. 5 and FIG. 6 in combination with FIG. 7, an example of the mechanics of a finger movement in the preferred embodiment is now provided. Lower solenoid 146 connects to the underside of the palm 106 and to the underside of the finger segment 113. Upon receiving a control signal from the controller 70, the solenoid driver 94 activates the lower solenoid 146 which retracts the plunger 302. The solenoid plunger 302 retracts thereby rotating the attached finger segment to the flexional position. The spring 164 connects to the top side of the palm 106 and the top side of finger segment 113. When the solenoid driver 94 deactivates the lower solenoid 146, and the spring 164, now under tension, returns the finger to the extensional position, and simultaneously extends the plunger 302. Similarly, the upper solenoid 148 connects to the underside of the finger segment 113 and to the underside of the finger segment 114. When the solenoid driver 94 activates the solenoid 148, the solenoid pulls the segment to the flexional position. The spring 166 connects to the topside of finger segment 113 and the topside of the finger segment 114. When the solenoid driver 94 deactivates solenoid 148, the spring 166 returns the finger to the extensional position. The remaining fingers (not shown) attached to the hand 104 operate in an identical way.

The elbow solenoid 132 and wrist solenoid 134 enable the up/down and side-to-side (or left-right) motions required only for certain letters, including ‘J’ and ‘Z’. Both elbow solenoid 132 and wrist solenoid 134 are optimally multi-position solenoids where the plunger 302 may be in three positions, a retracted position, neutral, or extended. The elbow solenoid 132 allows the arm subsystem 100 to move horizontally to the left and right and return to neutral. When the plunger 302 of elbow solenoid 132 is retracted, the arm subsystem 100 is displaced to the left. Conversely, when the plunger 302 of the elbow solenoid 132 is extended, the arm subsystem 100 is displaced to the right. The midway position where the forearm 102 is parallel with the upper arm 20 is the neutral position. The solenoid 134 enables the hand 104 to move vertically up and down and return to neutral. Wrist solenoid 134 may be in a (retracted) downward position, neutral, or an (extended) upward position.

Alternatively, a two position solenoid and spring system may be employed to displace the wrist 103 and elbow 105 joints 107.

The first finger solenoid 140, third finger solenoid 142 and fourth finger solenoid 144 and first finger side springs 162, third finger side spring 172 and fourth finger side spring 178 enable the first finger 502, third finger 506 and fourth finger 508 to alternatively spread and close. For example, when the solenoid driver 94 activates the solenoid 140, the solenoid 140 plunger 302 retracts, thereby pulling the finger segment 113 laterally to the left. When the solenoid driver 94 deactivates solenoid 140, the spring 162, now under tension, returns the segment 113 to its neutral position by pulling the segment to the right.

Three examples of the control process according to the invention are now provided. In order to form the letter “A”, upon initiation of the sequence by the user activated power switch 192, the following series of principal steps will be followed:

1. The elbow 105 will return to neutral position.

2. The wrist 103 will return to neutral position.

3. The wrist 103 bends upwards.

4. First finger 502, second finger 504, third finger 506, fourth finger 508 bend at the 2^{nd} joint.

5. The letter “A” is displayed on the digital display 50.

6. The sound “A” is broadcast through the audio device 60.

7. Pause.

To achieve these high level steps, the controller 70 performs the following steps:

1. Deactivate elbow solenoid 132 thereby returning the plunger 302 into the housing 301.

2. Deactivate wrist solenoid 134 thereby returning the plunger 302 into the housing 301.

3. Activate wrist solenoid 134 to the extended position of the plunger 302.

4. Activate first finger upper solenoid 148, second finger upper solenoid 152, third finger upper solenoid 156, fourth finger upper solenoid 160 (refer to FIG. 5) thereby retracting the plungers 302.

5. Read “A” from the memory 75.

6. Send “A” to the display controller 54; the display controller outputs “A” to the display 52.

7. Read “A” from the memory 75.

8. Send analog signals for “A” to the audio driver 62.

9. Processor 76 waits for a short time, (5 seconds in the preferred embodiment).

A similar series of steps is performed for each of the letters of the alphabet. Further examples are provided.

In order to form the letter “J”, upon initiation of the sequence by the user activated power switch 192, the following series of principal steps will be followed:

1. The elbow 105 will return to neutral position.

2. The wrist 103 will return to neutral position.

3. The wrist 103 bends upwards.

4. First finger 502, second finger 504, and third finger 506 bend at the 1^{st}, and 2^{nd} joints (fourth finger 508 remains vertical).

5. The thumb 500 bends at the thumb joint 352 across first finger 502 and second finger 504.

6. The wrist 103 bends forwards (downwards) simultaneously as the forearm 102 moves horizontally to the right.

7. The forearm 102 moves horizontally to the left.

8. The letter “J” is displayed on the digital display 50.

9. The sound “J” is broadcast through the audio device 60.

10. Pause.

To achieve these high level steps, the controller 70 performs the following steps:

1. Deactivate elbow solenoid 132 thereby returning the plunger 302 into the housing 301.

2. Deactivate wrist solenoid 134 thereby returning the plunger 302 into the housing 301.

3. Activate wrist solenoid 134 thereby extending the plunger 302.

4. Activate first finger upper solenoid 148, second finger upper solenoid 152, third finger upper solenoid 156 (refer to FIG. 5) thereby retracting the plungers 302.

5. Activate first thumb solenoid 136 (thereby rotating the thumb 500 forward) and activate second thumb solenoid 138 (thereby bending the thumb 500 at the joint 352 over the first finger 502 and the second finger 504).

6. Activate elbow solenoid 132 thereby moving forearm 102 to the right.

7. Deactivate wrist solenoid 134 thereby moving wrist 103 downwards.

8. Deactivate elbow solenoid 132 thereby moving forearm 102 to the left and back to a neutral position.

9. Read “J” from the memory 75.

10. Send “J” to the display controller 54; the display controller outputs “J” to the display 52.

11. Read “J” from the memory 75.

12. Send analog signals for “J” to the audio driver 62.

13. Processor 76 waits for a short time, (2 seconds in the preferred embodiment).

In order to form the letter “Z”, upon initiation of the sequence by the user activating switch 192, the following series of principal steps will be followed:

1. The elbow 105 will return to neutral position.

2. The wrist 103 will return to neutral position.

3. The wrist 103 bends upwards.

4. Second finger 504, third finger 506, fourth finger 508 bend at the 15 and 2nd joints (first finger 502 remains vertical).

5. The thumb 500 bends at the thumb joint 352 across first finger 502 and second finger 504.

6. The forearm 102 moves horizontally to the right.

7. The wrist 103 bends downwards simultaneously as the forearm 102 moves horizontally to the left.

8. The forearm 102 moves horizontally to the right.

9. The letter “Z” is displayed on the digital display 50.

10. The sound “Z” is broadcast through the audio device 60.

11. pause.

To achieve these high level steps, the controller 70 performs the following steps:

1. Deactivate elbow solenoid 132 thereby returning the plunger 302 into the housing 301.

2. Deactivate wrist solenoid 134 thereby returning the plunger 302 into the housing 301.

3. Activate wrist solenoid 134 to the extended position, thereby extending the wrist 103 upwards.

4. Activate second finger upper solenoid 152, third finger upper solenoid 156, fourth finger upper solenoid 160 (refer to FIG. 5) thereby retracting the plungers 302 and bending the finger segments 309.

5. Extend plunger 302 of elbow solenoid 132 fully thereby moving forearm 102 to the right.

6. Retract plunger 302 of wrist solenoid 134 thereby rotating wrist 103 downwards while simultaneously retracting plunger 302 of elbow solenoid 132 thereby moving forearm 102 to the left.

7. Extend plunger 302 of the elbow solenoid 132 thereby moving forearm 102 to the right.

8. Read “Z” from the memory 75.

9. Send “Z” to the display controller 54; the display controller outputs “Z” to the display 52.

10. Read “Z” from the memory 75.

11. Send analog signals for “Z” to the audio driver 62.

12. Processor 76 waits for a short time, (2 seconds in the preferred embodiment).

A similar series of steps will be followed for each of the letters “A” through “Z”, adjusted for each letter.

In this manner the doll 10 concurrently demonstrates the AMA with electromechanical arm subsystem 100, displays the Latin letter being signed on visual display 50, and audibly outputs the letter being signed via audio device 60. This provides a visual representation, an audible representation and the actual hand sign for each letter of the AMA. The concurrent output of the Latin letter, the corresponding vocalization of the letter and the AMA hand formation is advantageous from a pedagogical standpoint as the user may learn more effectively from any one of the three media, or from a combination thereof, and can more effectively imitate and practise the AMA.

In a variation, finger segments 110 are hollow plastic cylinders and the solenoids 130 are disposed within the finger segments 110 and anchored to the interior surface.

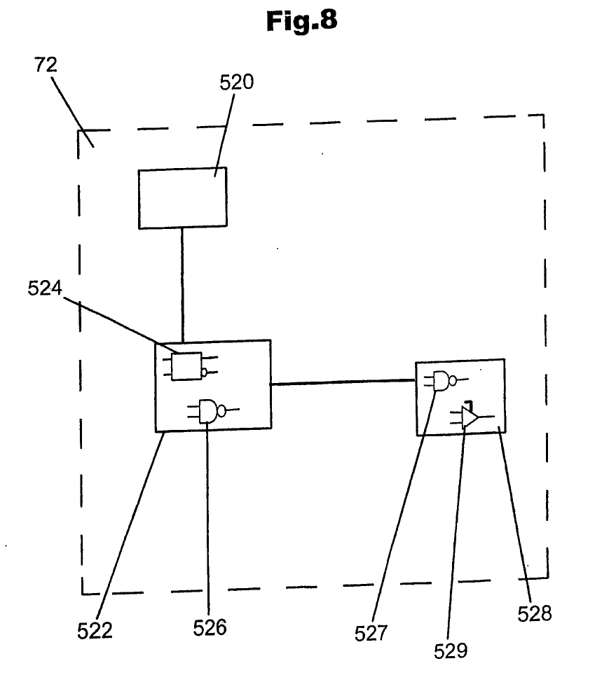

Referring now to FIG. 8, a variation of the control section 72 is shown. The control section 72 is comprised of an external memory system 520 such as a flash memory, a processing system 522 comprised of discrete digital components (flip-flips 524, logic gates 526, and other components as required) for processing (commercially available), and an I/O section 528 comprised of discrete analog components 529 and discrete digital components 527. In this variation, the discrete digital components, 524 and 526, perform the function of the CPU in the preferred embodiment.

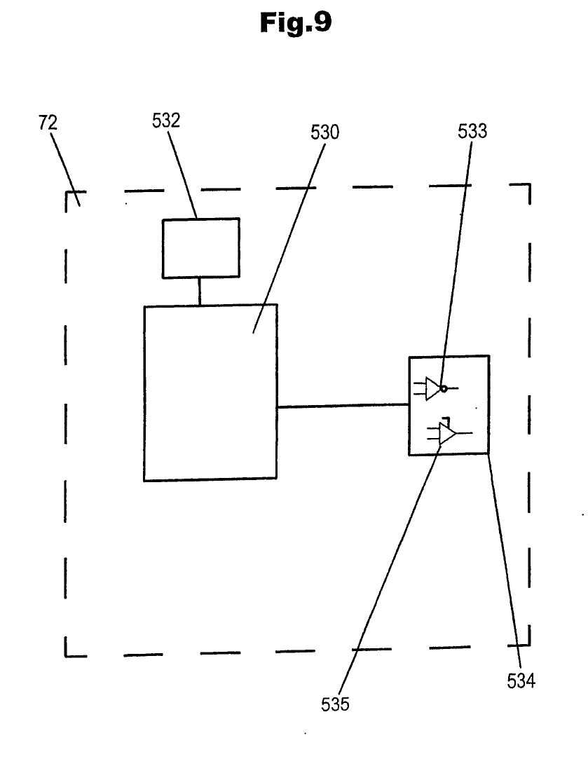

Referring now to FIG. 9, a further variation wherein the control section 72 is comprised of a programmable logic controller (“PLC”) 530 is shown. The PLC 530 is connected to an external memory system 532 such as flash memory, and an I/O section 534 comprised of discrete analog components 535 and discrete digital components 533. The PLC 530 is configured to provide the correct outputs to the various subcomponents.

Referring again to FIG. 1, in the preferred method, the doll 10 is viewed from the front. The arm subsystem 100 is shown slightly in front of the torso 16 and slightly above the waistline 17. This is the most common signing position. The user activates the switch 192 (not shown) at the back of the doll 10 and thereby activates the doll 10. The audio output 62 of the doll 10 then states, for instance “Hi, I'm Signing Sandy. Let's sing and sign the Alphabet Song.” The traditional “ABC” song is then played through the audio output 62 and the doll's arm subsystem 100 then forms each of the 26 letters of the AMA, following the order of the alphabet, “A” through “Z”. A brief pause is made between each finger and hand position. Additionally, the electronic display 52 displays the Latin letter being signed.

It is recommended that the user watch as the doll 10 signs the AMA, and initiates the finger movements with his or her own hand. Once all letters of the alphabet have been demonstrated, the arm subsystem 100 will return to its neutral position and repeat the signing and singing process. The user terminates the activity of the doll 10 by deactivating the switch 192.

A child is the preferred user of the doll; however the doll could equally be used to educate adults or even animals, particularly primates.

In an alternative embodiment, the user may demand a particular sign language element be demonstrated via a verbal recognition interface in the doll 10, or by a sensor or touch pad. The doll 10 then demonstrates the particular sign language element which may be a letter, word or phrase.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

I claim:

1. An apparatus for a sign language element demonstrating doll comprising an electromechanical arm and hand, said hand being positionally adjustable in a manner operative to demonstrate said sign language elements.

2. An apparatus according to claim 1 which further comprises an audio system for vocalizing the verbal equivalent of said sign language elements.

3. An apparatus according to claim 1 which further comprises a display system for displaying the Latin alphabet equivalent of said sign language elements.

4. An apparatus according to claim 1 which further comprises a speaker and a display screen which simultaneously broadcast and display the equivalent of said sign language elements which are being demonstrated by said electromechanical hand of said doll.

5. An apparatus according to claim 4 wherein said sign language elements are the American Manual Alphabet (“AMA”) signs corresponding to the characters of the Latin alphabet.

6. An apparatus according to claim 5 wherein said electromechanical hand displays said AMA signs in sequence, while simultaneously broadcasting the equivalent name of said sign in a spoken language and displaying the Latin alphabet equivalent of said sign on said display screen.

7. An apparatus according to claim 1 wherein said sign language element is a sign representing a single letter of an alphabet.

8. An apparatus according to claim 1 wherein said sign language element is a sign representing a word in a spoken language.

9. An apparatus according to claim 1 wherein said sign language element is a sign representing a phrase in a spoken language.

10. A doll for demonstrating sign language, comprising an electromechanical arm attached to a right shoulder having a forearm segment, a hand segment and finger segments.

11. The doll of claim 10 further comprising an electronic controller including circuit board, a processor, a memory and interface headers.

12. The doll of claim 11 further comprising an electronic display.

13. The doll of claim 11 further comprising an audio means disposed in said doll.

14. The doll of claim 11 further comprising an electronic display screen, an audio output and a power supply disposed in said doll.

15. The doll according to claim 11 wherein said hand is comprised of a plurality of joints, springs and solenoids wherein when said solenoids are activated, said finger segments are flexed about said joint and wherein when said solenoids are deactivated, said springs return said finger segments to a neutral extended position.

16. The doll according to claim 13 further comprising a wrist joint and an elbow joint.

17. The doll according to claim 16 wherein said wrist joint and said elbow joint each include a multi-position solenoid, operable in at least three positions.

18. The doll according to claim 12 wherein said electronic display is an alphanumeric light emitting diode display.

19. The doll according to claim 13 wherein said audio means is a piezo-electric speaker.

20. The doll according to claim 11 wherein said processor is a microcontroller.

21. The doll according to claim 14 wherein said power supply is a rechargeable battery.

22. The doll according to claim 21 wherein said power supply is a 6 volt battery.

23. An electromechanical hand having a hand segment and finger segments for demonstrating sign language comprised of:
a. four independently controllable fingers having at least one joint each and moveably attached to said hand segment by one said joint;
b. an independently controllable thumb having at least one joint and moveably attached to said hand segment by one said joint; and
c. a controller having a processor and a memory and being attached to said hand.

24. The hand of claim 23 additionally comprising an electromechanical arm having a forearm segment, said hand being moveably attached at a distal end of said forearm segment, such that said forearm segment is moveable to demonstrate sign language.

25. The hand according to claim 24 wherein an electronic display is attached to said electromechanical arm.

26. The apparatus according to claim 25 wherein said electronic display is an alphanumeric light emitting diode.

27. The apparatus according to claim 25 wherein said electronic display means is a backlit liquid crystal display.

28. The apparatus according to claim 24 wherein an audio output is attached to said electromechanical arm.

29. The hand according to claim 28 wherein said audio output is a piezo-electric speaker.

30. The hand according to claim 23 wherein at least one spring and at least one electric solenoid is disposed at each said joint wherein when said solenoids are activated, said segments are flexed and wherein when said solenoids are deactivated, said springs extend said segments to a neutral anatomical position.

31. The hand according to claim 23 wherein said memory is an interchangeable memory card.

32. A method of sequentially demonstrating the hand and finger positions of the American Manual Alphabet using an electromechanical arm while concurrently displaying the letter being signed on a digital display and concurrently providing an audial representation of the letter being signed through an audio device.

33. A method of demonstrating sign language with an electromechanical doll providing the steps of:
a. turning a switch on the doll to an on position; and
b. controlling an electromechanical arm, hand, and fingers to form a physical representation of a sign language component.

34. The method of claim 33 further comprising the step of:
c. simultaneously controlling an audio output device to emit a sound corresponding to said sign language component.

35. The method of claim 34 further comprising the step of:
d. simultaneously controlling a display device to show the Latin character corresponding to said sign language component.

36. A method of demonstrating sign language with a doll having an electronic control device, an audio output device, a visual display device and a plurality of joints manipulatable by a flexional device comprising the steps of:
a. controlling said manipulatable joints in at least one finger of said doll to form a sign language; and
b. simultaneously emitting the sound corresponding to said sign from said audio output device; and
c. simultaneously displaying the Latin letter equivalent of said sign on said visual display device.

37. The method of claim 36 wherein step a. further comprises controlling manipulatable joints in an elbow and wrist.

38. The method of claim 36 wherein said flexional devices are electrical solenoids, and further comprising the step of controlling said solenoids to flex said fingers, hand and wrist to form said sign character.

39. The method of claim 38 further comprising the steps of:
d. deactivating said solenoids;
e. returning said fingers, hand and wrist to a neutral position by means of at least one spring under tension.
